(19) United States
(12) Patent Application Publication
(10) Pub. No.: US 2023/0186457 A1
(43) Pub. Date: Jun. 15, 2023

(54) MACHINE-LEARNING DEVICE AND MACHINE-LEARNING SYSTEM

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 17/998,351

(22) PCT Filed: May 13, 2021
(86) PCT No.: PCT/JP2021/018191

§ 371 Date: Nov. 9, 2022

(30) Foreign Application Priority Data
May 18, 2020 (JP) 2020-086733

(51) Int. Cl. G06T 7/00

(52) U.S. Cl. CPC G06T 7/0008; G06T 2207/20081

(57) ABSTRACT

The purpose of the present invention is to provide a machine-learning device and a machine-learning system which can reduce the size of learning data and perform learning fast. The machine-learning device comprises: a machine-learning unit which learns learning data including images and labels for the images; an image processing unit which processes the images by using an image processing program; a small-size learning data creation unit which cuts off, from the image, a partial image to be used for learning by the machine-learning unit, and creates small-size learning data including the partial image; and a learning data control unit which stores the small-size learning data in association with the image processing program, wherein the machine-learning unit learns the learning data or the small-size learning data.

### TECHNICAL FIELD

The present invention relates to a machine-learning device and a machine-learning system.

### BACKGROUND ART

Conventionally, in a robot system, machine learning utilizing a learner such as a deep neural network is used, as a method of detecting and inspecting an object from features captured in an image. In a system using such machine learning as described above, annotation is performed as a stage prior to perform learning, in which a label indicating whether there is an abnormality in an image and whether a detection position is correct, for example, is associated with image data. Annotation is performed in such a manner that a person visually checks each image one by one to determine whether there is an abnormality in an object in the image.

Note herein that a pair of an image and a label represents a piece of learning data, and a collection of such pieces of learning data represents a learning data set. Then, the learner uses all or some of learning data sets to perform machine learning (for example, see Patent Documents 1 and 2).
Patent Document 1: Japanese Unexamined Patent Application, Publication No. 2019-15654
Patent Document 2: Japanese Unexamined Patent Application, Publication No. 2018-151843

### DISCLOSURE OF THE INVENTION

### Problems to be Solved by the Invention

Note herein that there is a case where, when learning is performed, only a part of an image file is used. In such a case, if all images are read each time learning is performed, there may be an extended period of time for the learning. Furthermore, retaining all images may lead to an increase in size of a learning data set. As such, what is demanded is to reduce learning data in size to perform learning fast.

### Means for Solving the Problems

A machine-learning device according to the present disclosure includes: a machine-learning unit configured to perform learning of learning data containing images and labels assigned to the images; an image processing unit configured to perform image processing on the images by using an image processing program; a small-size learning data creation unit configured to cut off, from each of the images, a partial image to be used for learning by the machine-learning unit, and to create small-size learning data containing the partial images; and a learning data control unit configured to store the small-size learning data in association with the image processing program. The machine-learning unit performs learning of the learning data or the small-size learning data.

A machine-learning device according to the present disclosure includes: a machine-learning unit configured to perform learning of learning data containing images and labels assigned to the images; an image processing unit configured to perform image processing on the images by using an image processing program; a small-size learning data creation unit configured to cut off, from each of the images, a partial image to be used for learning by the machine-learning unit, and to create small-size learning data containing the partial images; and a learning data control unit configured to store a learning model used to perform learning of the learning data and a small-size learning model used to perform learning of the small-size learning data in association with each other. The machine-learning unit performs learning of the learning data or the small-size learning data.

A machine-learning system includes a plurality of the machine-learning devices according to the present disclosure, in which the machine-learning units that the plurality of machine-learning devices respectively include share a learning model, and the machine-learning units that the plurality of machine-learning devices respectively include perform learning for the learning model being shared.

A machine-learning system includes a plurality of the machine-learning devices according to the present disclosure, in which the machine-learning units that the plurality of machine-learning devices respectively include share a small-size learning data, and the machine-learning units that the plurality of machine-learning devices respectively include perform learning by using the small-size learning data being shared.

### Effects of the Invention

According to the present invention, it is possible to reduce learning data in size to perform learning fast.

### BRIEF DESCRIPTION OF THE DRAWINGS

FIG. 1 is a view illustrating an outline of an image processing system to which a machine-learning device according to an embodiment is applied;

FIG. 2 is a view illustrating an outline of a robot system to which the machine-learning device according to the present embodiment is applied;

FIG. 3 is a view illustrating a configuration of the machine-learning device;

FIG. 4 is a view illustrating an example of assigning a label to a detection result;

FIG. 5 is a view illustrating an example of extracting a partial image; and

FIG. 6 is a flowchart illustrating a flow of processing using small-size learning data in the machine-learning device.

### PREFERRED MODE FOR CARRYING OUT THE INVENTION

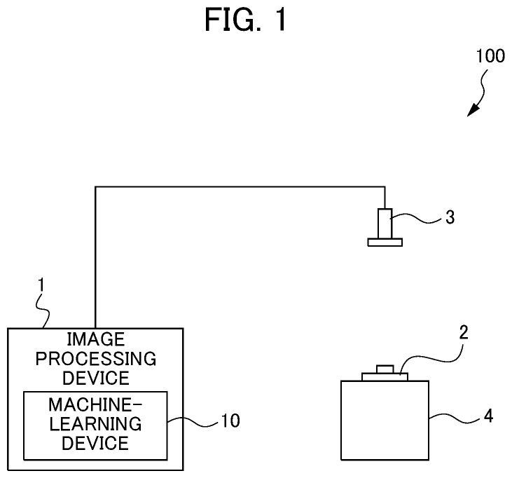

An example of an embodiment of the present invention will now be described herein. FIG. 1 is a view illustrating an outline of an image processing system 100 to which a machine-learning device 10 according to the present embodiment is applied. As illustrated in FIG. 1, the image processing system 100 includes an image processing device 1, an object 2, a visual sensor 3, and a workbench 4.

The image processing system 100 is configured to allow the visual sensor 3 to capture an image of the object 2 arranged on the workbench 4 and to allow the image processing device 1 to process data of the captured image. Furthermore, the image processing device 1 includes the machine-learning device 10. The machine-learning device 10 is configured to use a learning model to perform learning of a learning data set containing one or more pieces of learning data containing images and labels.

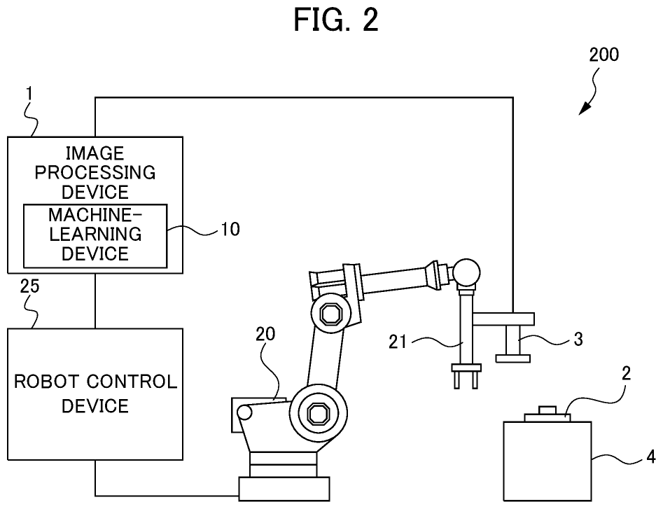

FIG. 2 is a view illustrating an outline of a robot system 200 to which the machine-learning device 10 according to the present embodiment is applied. As illustrated in FIG. 2, the robot system 200 includes the image processing device 1, the object 2, the visual sensor 3, the workbench 4, a robot 20, and a robot control device 25.

A hand or a tool is attached at a distal end of an arm 21 of the robot 20. Under the control of the robot control device 25, the robot 20 performs a task, such as handling or processing, on the object 2. Furthermore, the visual sensor 3 is attached at the distal end of the arm 21 of the robot 20. Note that the visual sensor 3 may not be attached to the robot 20, but may be fixedly installed at a predetermined position, for example.

Under the control of the image processing device 1, the visual sensor 3 captures an image of the object 2. For the visual sensor 3, for example, a two-dimensional camera having an imaging element constructed from a charge coupled device (CCD) image sensor and an optical system including lenses may be used, or a stereo camera achieving three-dimensional measurements may be used.

The robot control device 25 is configured to execute a robot program for the robot 20 to control operation of the robot 20. At that time, the robot control device 25 compensates operation of the robot 20 with respect to a position of the object 2, which is detected by the image processing device 1, to allow the robot 20 to perform a predetermined task.

Furthermore, similarly to FIG. 1, the image processing device 1 includes the machine-learning device 10. The machine-learning device 10 is configured to use a learning model to perform learning of a learning data set containing one or more pieces of learning data containing images and labels.

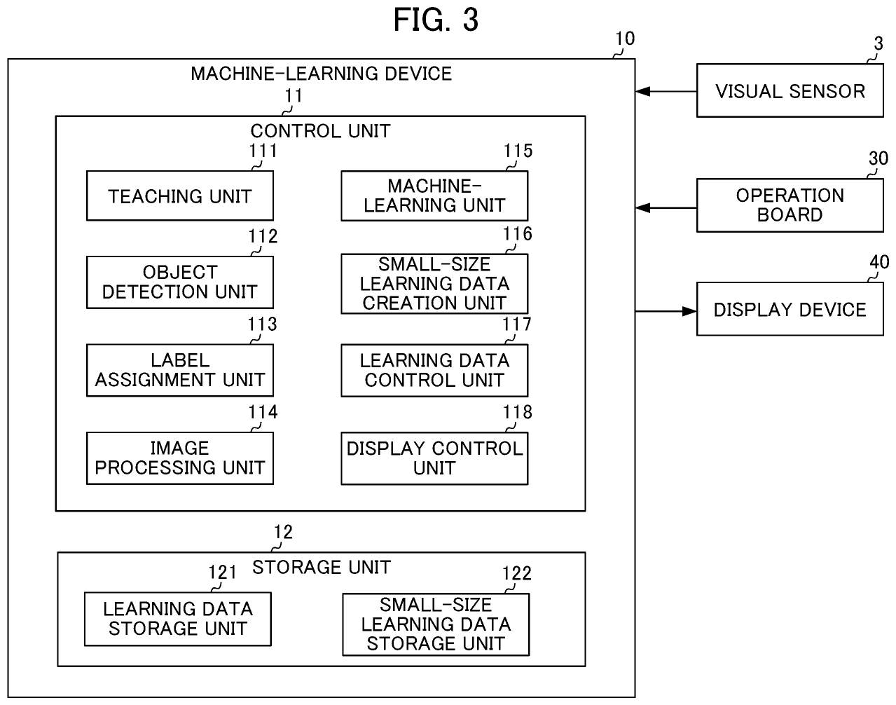

FIG. 3 is a view illustrating a configuration of the machine-learning device 10. The machine-learning device 10 is a device for performing machine learning for the robot 20. The machine-learning device 10 includes a control unit 11 and a storage unit 12.

The control unit 11 is a processor such as a central processing unit (CPU), and is configured to execute programs stored in the storage unit 12 to achieve various functions.

The control unit 11 includes a teaching unit 111, an object detection unit 112, a label assignment unit 113, an image processing unit 114, a machine-learning unit 115, a small-size learning data creation unit 116, a learning data control unit 117, and a display control unit 118.

The storage unit 12 represents a storage device including, for example, a read only memory (ROM) storing an operating system (OS), application programs, and other programs, a random access memory (RAM), and a hard disk drive and a solid state drive (SSD) storing various types of information. The storage unit 12 is configured to store various types of information such as learning models, learning data, and robot programs.

Next, machine learning that the machine-learning device 10 according to the present embodiment performs will now be described herein. The teaching unit 111 is configured to teach a model pattern representing features in an image of the object 2. The object 2 that is desired to be taught as the model pattern is arranged within a field of view of a visual sensor 3 for capturing an image of the object 2. It is desirable that an image is captured while a positional relationship between the visual sensor 3 and the object 2 is identical to one when the object 2 is to be detected.

The teaching unit 111 designates a region containing the object 2 in the captured image as a model pattern designation region having a rectangular or circular shape. The teaching unit 111 extracts, as feature points, edge points within a range of the model pattern designation region, and acquires physical quantities such as positions of the edge points, their postures (directions of brightness gradient), and magnitudes of the brightness gradient. Furthermore, the teaching unit 111 defines a model pattern coordinate system within the designated region, and performs conversions of the positions of the edge points and their postures from values expressed in an image coordinate system into values expressed in the model pattern coordinate system.

The physical quantities of the extracted edge points are stored in the storage unit 12 as the feature points constituting a model pattern. Note that, although, in the present embodiment, edge points are used as feature points, widely known feature points called Scale Invariant Feature Transform (SIFT) may be used, for example. Note that, for teaching of a model pattern by the teaching unit 111, such a method as disclosed in Japanese Unexamined Patent Application, Publication No. 2017-91079 may be used, for example.

The object detection unit 112 is configured to use a model pattern to detect an image of an object W from one or more input images containing the object 2. Specifically, one or more input images including an image of the object 2 are first prepared. Then, the object detection unit 112 uses the model pattern to detect an image of the object W from each of the one or more input images containing the object 2.

Note herein that, since it is desirable that it is possible to acquire both correct detections and erroneous detections, a range for detection parameters for performing detections should be expanded. The detection parameters may include, for example, a range of sizes with respect to a model, a range of shear deformation, a range of positions to be detected, a range of angles, a percentage of coincidence between edges in a model pattern and edges in an image, a threshold value for a distance, according to which the edges in the model pattern and the edges in the image are deemed to be coincident, and a threshold value for edge contrast.

The label assignment unit 113 is configured to assign, based on a determination of a detection result of the object 2 by the user, a label (annotation) to the detection result. Specifically, the detection result of the object 2 is displayed on a display device 40 coupled to the machine-learning device 10. The user visually checks the detection result and assigns a label such as acceptable (OK) or unacceptable (NG) to the detection result. When a plurality of objects W are detected from one input image, a plurality of labels are assigned to the one input image.

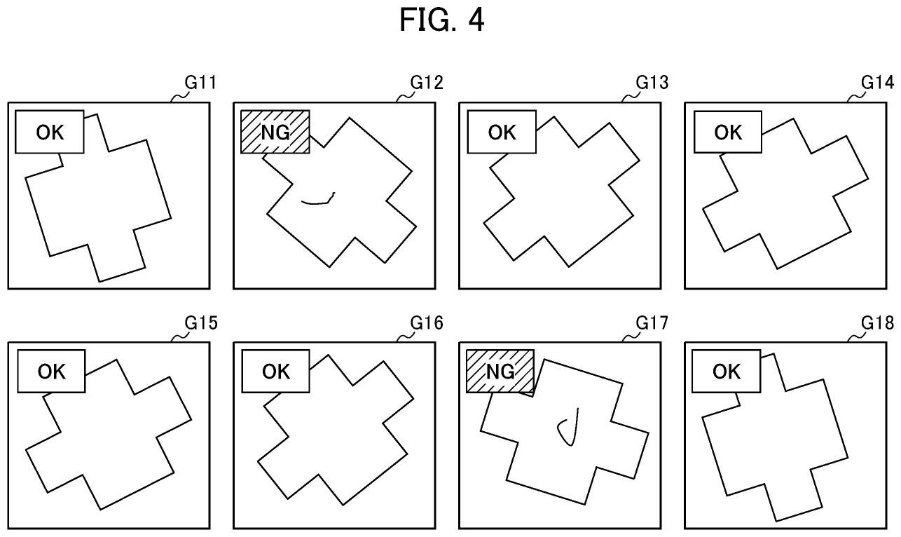

FIG. 4 is a view illustrating an example of assigning a label to a detection result. In the example in FIG. 4, the label assignment unit 113 assigns the label of unacceptable (NG) to two images G12 and G17, and assigns the label of acceptable (OK) to six images G11, G13, G14, G15, G16, and G18.

For example, when a detection result indicates that there is an erroneous detection or an abnormality, the user assigns the label of unacceptable (NG). Furthermore, when a detection result is equal to or greater than a predetermined threshold value, the user may assign the label of acceptable (OK), and, when a detection result is below the predetermined threshold value, the user may assign the label of unacceptable (NG). Furthermore, the user may correct a label automatically assigned by the machine-learning device 10. Note that, although, in the above description, a classification having two classes of acceptable (OK) and unacceptable (NG) are used as labels, a classification having three or more classes may be used.

The image processing unit 114 is configured to associate an image with a label assigned to the image, and regards the image and the label as learning data. Note herein that data to be stored as labels may contain, in addition to the labels of acceptable (OK) and unacceptable (NG) that the user assigns, data that a detection result contains. For example, since, in the present embodiment, information such as a position, a posture, and a size of an object, which are included in a detection result, is used to cut off an object from an input image, it is necessary to store the information as labels. Such information may be unnecessary as long as such an image has been cut off when creating learning data. The image processing unit 114 stores, in a learning data storage unit 121, a collection (a learning data set) of pieces of learning data containing images and labels assigned to the images.

The machine-learning unit 115 is configured to perform learning of a learning data set containing images and labels assigned to the images. The machine-learning unit 115 inputs pixel values of the images into the learning model, and calculates a degree of coincidence (a score). Thereby, the machine-learning unit 115 is able to determine whether a detection is correct or not.

The small-size learning data creation unit 116 is configured to cut off, from each of the images in the learning data, a partial image to be used for learning by the machine-learning unit 115, and to create small-size learning data containing the partial images. Specifically, the small-size learning data creation unit 116 acquires the learning data from the learning data storage unit 121. The small-size learning data creation unit 116 extracts, from each of the images in the learning data, by using information such as a position, a posture, and a size of an object, which are included in a label, a partial image containing the object 2, associates the partial image with the label, and creates small-size learning data containing the partial images and the labels. A label that small-size learning data contains may not include information that has been used to cut off a partial image.

A plurality of partial images may sometimes be cut off from one image. On the other hand, no partial image may sometimes be cut off from one image. One reason of these phenomena is that, although images were stored in a learning data set, no object was detected in the images or, although an object was detected, a user had selected to assign no label.

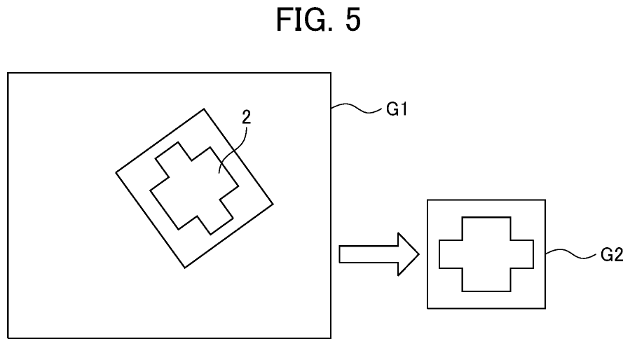

FIG. 5 is a view illustrating an example of extracting a partial image. In the example in FIG. 5, the small-size learning data creation unit 116 extracts a partial image G2 from an image G1. Then, the small-size learning data creation unit 116 associates the extracted partial image with a label assigned by the label assignment unit 113, and regards the partial image and the label as learning data.

The small-size learning data creation unit 116 may further perform image processing on the extracted partial image, and may store the image-processed, extracted partial image as small-size learning data. For example, when data of a small-size partial image or data of features extracted from a partial image is regarded as an input into the machine-learning unit 115, the small-size learning data creation unit 116 stores such data that has undergone image processing as small-size learning data. Thereby, the small-size learning data creation unit 116 is able to reduce data in size and to reduce an amount of calculation during learning.

Then, the small-size learning data creation unit 116 regards a collection of pieces of small-size learning data containing partial images and labels as a small-size learning data set.

The machine-learning unit 115 inputs pixel values of each partial image into a learning model, and calculates a degree of coincidence (a score). Note herein that a degree of coincidence is represented by a value ranging from 0 to 1.

The machine-learning unit 115 sets 1.0 when a label in a detection result indicates that it is correct, and sets 0.0 when the label indicates that it is not correct, and then calculates an error from the calculated degree of coincidence (the score). The machine-learning unit 115 back-propagates the error in the learning model, and updates a parameter (for example, weighting) for the learning model. Then, the machine-learning unit 115 repeats such processing the number of times identical to the number of detection results (N number) used for learning.

The learning data control unit 117 is configured to store, in the storage unit 12, the small-size learning data created by the small-size learning data creation unit 116 in association with the image processing program. Specifically, the learning data control unit 117 stores the small-size learning data in a file constituting the image processing program. Due to its smaller file size, it is possible to store the small-size learning data in a file constituting the image processing program.

Furthermore, the learning data control unit 117 may store small-size learning data as one or more files in the small-size learning data storage unit 122, and may store a file path to the small-size learning data in a file constituting an image processing program.

Note herein that the image processing unit 114 performs image processing on image data by using the image processing program. The image processing program is stored in the storage unit 12. The image processing program is a program that the user uses to execute desired image processing. For example, the image processing program may use a model pattern to detect the object 2 to determine whether a detected region represents a correct detection. Such processing using an image processing program as described above is disclosed in Japanese Unexamined Patent Application, Publication No. 2018-151843 (Patent Document 2), for example.

By storing small-size learning data in association with an image processing program, the learning data control unit 117 is able to perform learning by using the small-size learning data when performing again learning of a learning model stored in the image processing program or when performing additional learning. When performing additional learning, the machine-learning unit 115 uses a new learning data set and an existing small-size learning data set for the learning. A small-size learning data may be stored in association with a learning model.

Furthermore, the learning data control unit 117 deletes learning data from the learning data storage unit 121 after the small-size learning data creation unit 116 has created small-size learning data. Thereby, the machine-learning device 10 is able to reduce in size a storage region that is to be required for machine learning. Furthermore, the learning data control unit 117 may delete an image, to which no label has been assigned, in learning data, after the small-size learning data creation unit 116 has created small-size learning data.

Furthermore, the learning data control unit 117 may select, when there is a smaller storage region remaining in the storage unit 12, a piece of learning data in a learning data set and may delete the selected piece of learning data. For selecting a piece of learning data, it is possible to use a desired method. For example, the learning data control unit 117 may delete older pieces of learning data in order. Even when a piece of learning data is deleted, small-size learning data is still present, making it possible to perform again learning by using the small-size learning data. Furthermore, the small-size learning data creation unit 116 may create small-size learning data at the time when the learning data control unit 117 deletes a piece of learning data.

The display control unit 118 is configured to allow the display device 40 to display small-size learning data. Displaying of a partial image by the display control unit 118 is achieved by using a widely known method (for example, see Japanese Unexamined Patent Application, Publication No. 2017-151813). By using small-size learning data, the display control unit 118 is able to allow a partial image in a learning data set containing small-size learning data to be promptly displayed.

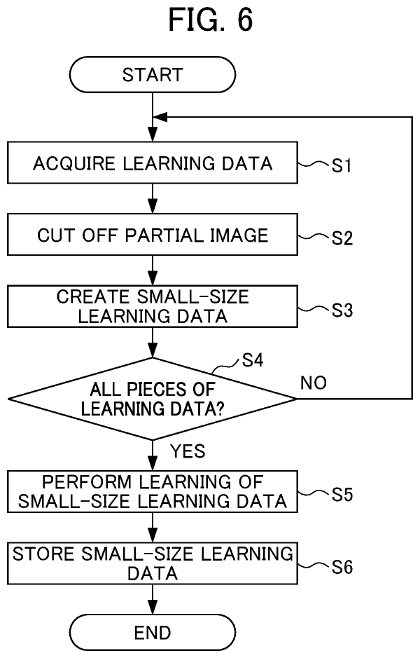

FIG. 6 is a flowchart illustrating a flow of processing using small-size learning data in the machine-learning device 10. At Step S1, the small-size learning data creation unit 116 acquires learning data from the learning data storage unit 121.

At Step S2, the small-size learning data creation unit 116 extracts a partial image containing the object 2 from each of images in the learning data. At Step S3, the small-size learning data creation unit 116 associates the partial image with a label, and creates small-size learning data containing the partial images and the labels.

At Step S4, the small-size learning data creation unit 116 determines whether small-size learning data has been created from all pieces of learning data in the learning data storage unit 121. When small-size learning data has been created from all pieces of learning data (YES), the processing proceeds to Step S5. On the other hand, when small-size learning data has not yet been created from all pieces of learning data (NO), the processing proceeds to Step S6.

At Step S5, the machine-learning unit 115 performs machine learning by using the small-size learning data. At Step S6, the learning data control unit 117 stores, in the storage unit 12, the small-size learning data created by the small-size learning data creation unit 116 in association with the image processing program.

As described above, according to the present embodiment, the machine-learning device 10 includes: the machine-learning unit 115 configured to perform learning of learning data containing images and labels assigned to the images; the image processing unit 114 configured to perform image processing on the images by using an image processing program; the small-size learning data creation unit 116 configured to cut off, from each of the images, a partial image to be used for learning by the machine-learning unit, and to create small-size learning data containing the partial images; and the learning data control unit 117 configured to store the small-size learning data in association with the image processing program. The machine-learning unit 115 performs learning of the learning data or the small-size learning data.

Thereby, by using small-size learning data when again performing learning, the machine-learning device 10 is not required to cut off a partial image, but is able to perform learning fast. Furthermore, by storing small-size learning data, the machine-learning device 10 is able to reduce in size a learning data set to be stored in the storage unit 12. Therefore, the machine-learning device 10 is able to reduce in size learning data and to perform learning fast.

Furthermore, the learning data control unit 117 deletes learning data after the small-size learning data creation unit 116 has created small-size learning data. Thereby, the machine-learning device 10 is able to reduce in size a storage region that is to be required for machine learning. Furthermore, the learning data control unit 117 deletes an image, to which no label has been assigned, in learning data, after the small-size learning data creation unit 116 has created small-size learning data. Thereby, the machine-learning device 10 is able to reduce in size a storage region that is to be required for machine learning.

Furthermore, the machine-learning device 10 further includes the display control unit 118 configured to allow the display device 40 to display small-size learning data. By using small-size learning data in which its size has been reduced, the machine-learning device 10 is able to allow a partial image in a learning data set containing small-size learning data to be promptly displayed.

Furthermore, the learning data control unit 117 stores small-size learning data in a file constituting an image processing program. Due to its smaller file size, it is possible to store small-size learning data in an image processing program. Thereby, the machine-learning device 10 is able to handle a learning data set within a single file containing an image processing program, making it possible to improve the user's convenience.

Furthermore, the learning data control unit 117 may store small-size learning data as one or more files in the small-size learning data storage unit 122, and may store a file path to the small-size learning data in a file constituting an image processing program. Thereby, the machine-learning device 10 is able to handle a small-size data set, making it possible to improve the user's convenience.

Note that, although, in the embodiment described above, a case where there is the single machine-learning device 10 has been described, there may be a machine-learning system where there is a plurality of the machine-learning devices 10. When there is a plurality of the machine-learning devices 10, a learning model that one of the machine-learning devices 10 has stored may be shared among the other ones of the machine-learning devices 10. By allowing a learning model to be shared among a plurality of the machine-learning devices 10, it is possible to perform learning in a distributed manner among the machine-learning devices 10, allowing the machine-learning system to improve the efficiency of learning.

Furthermore, when there is a plurality of the machine-learning devices 10, a learning data set containing small-size learning data that one of the machine-learning devices 10 has stored may be shared among the other ones of the machine-learning devices 10. By sharing small-size learning data, instead of sharing learning data, the machine-learning system is able to reduce a load on a network.

Note that, although, in the embodiment described above, the learning data control unit 117 stores small-size learning data in association with an image processing program, the learning data control unit 117 may store a learning model used to perform learning of learning data in association with a small-size learning model used to perform learning of small-size learning data.

Although the embodiments of the present invention have been described above, it is possible to achieve the machine-learning device described above through hardware, software, or combination thereof. Furthermore, it is possible to achieve a control method that is to be implemented by the machine-learning device described above through hardware, software, or combination thereof. In here, achievement through software means achievement when a computer reads and executes a program.

It is possible to use a non-transitory computer readable medium that varies in type to store the program, and to supply the program to a computer. Examples of the non-transitory computer readable medium include tangible storage media that vary in type. Examples of the non-transitory computer readable medium include magnetic recording media (for example, hard disk drive), magneto-optical recording media (for example, magneto-optical disc), compact disc read only memories (CD-ROM), compact disc-recordable (CD-R), compact disc-rewritable (CD-R/W), semiconductor memories (for example, mask ROM, programmable ROM (PROM), erasable PROM (EPROM), flash ROM, and random access memory (RAM)).

Furthermore, although the foregoing embodiment represents a preferable embodiment of the present invention, the scope of the present invention should not be limited to only the embodiment described above. Embodiments that have been variously changed without departing from the gist of the present invention are also implementable.

### EXPLANATION OF REFERENCE NUMERALS

1 Image processing device
2 Object
3 Visual sensor
4 Workbench
10 Machine-learning device
20 Robot
25 Robot control device
100 Image processing system
111 Teaching unit
112 Object detection unit
113 Label assignment unit
114 Image processing unit
115 Machine-learning unit
116 Small-size learning data creation unit
117 Learning data control unit
118 Display control unit
200 Robot system

1. A machine-learning device comprising:
a machine-learning unit configured to perform learning of learning data containing images and labels assigned to the images;
an image processing unit configured to perform image processing on the images by using an image processing program;
a small-size learning data creation unit configured to cut off, from each of the images, a partial image to be used for learning by the machine-learning unit, and to create small-size learning data containing the partial images; and
a learning data control unit configured to store the small-size learning data in association with the image processing program,
wherein the machine-learning unit performs learning of the learning data or the small-size learning data.

2. The machine-learning device according to claim 1, wherein the learning data control unit deletes the learning data after the small-size learning data creation unit has created the small-size learning data.

3. The machine-learning device according to claim 1, wherein the learning data control unit deletes some of the images in the learning data, the some of the images being images not assigned with the labels, after the small-size learning data creation unit has created the small-size learning data.

4. The machine-learning device according to claim 1, further comprising a display control unit configured to allow a display device to display the small-size learning data.

5. The machine-learning device according to claim 1, wherein the learning data control unit stores the small-size learning data in a file constituting the image processing program.

6. The machine-learning device according to claim 1, wherein the learning data control unit stores the small-size learning data as one or more files, and stores a file path to the small-size learning data in a file constituting the image processing program.

7. A machine-learning device comprising:
a machine-learning unit configured to perform learning of learning data containing images and labels assigned to the images;
an image processing unit configured to perform image processing on the images by using an image processing program;
a small-size learning data creation unit configured to cut off, from each of the images, a partial image to be used for learning by the machine-learning unit, and to create small-size learning data containing the partial images; and
a learning data control unit configured to store a learning model used to perform learning of the learning data and a small-size learning model used to perform learning of the small-size learning data in association with each other,
wherein the machine-learning unit performs learning of the learning data or the small-size learning data.

8. A machine-learning system comprising a plurality of the machine-learning devices according to claim 1,
wherein
the machine-learning units that the plurality of machine-learning devices respectively include share a learning model, and
the machine-learning units that the plurality of machine-learning devices respectively include perform learning for the learning model being shared.

9. A machine-learning system comprising a plurality of the machine-learning devices according to claim 1,
wherein
the machine-learning units that the plurality of machine-learning devices respectively include share a small-size learning data, and
the machine-learning units that the plurality of machine-learning devices respectively include perform learning by using the small-size learning data being shared.
